(19) United States
(12) Patent Application Publication
(10) Pub. No.: US 2026/0044670 A1
(43) Pub. Date: Feb. 12, 2026

(54) INFERENCE DEVICE, LEARNING DEVICE, INFERENCE METHOD, METHOD FOR GENERATING TRAINED MODEL, NON-TRANSITORY STORAGE MEDIUM STORING INFERENCE PROGRAM, AND NON-TRANSITORY STORAGE MEDIUM STORING LEARNING PROGRAM

(71) Applicant: Mitsubishi Electric Corporation, Tokyo (JP)

(72) Inventor: Hiroyasu ITSUI, Tokyo (JP)

(73) Assignee: Mitsubishi Electric Corporation, Tokyo (JP)

(21) Appl. No.: 19/364,372

(22) Filed: Oct. 21, 2025

Related U.S. Application Data
(63) Continuation of application No. PCT/JP2023/018368, filed on May 17, 2023.

(51) Int. Cl. G06F 40/166; G06F 40/242; G06N 3/08

(52) U.S. Cl. CPC G06F 40/166; G06F 40/242; G06N 3/08

(57) ABSTRACT

The purpose is to obtain an inference device capable of generating an ethically appropriate sentence. The inference device according to the present disclosure includes: a mask data acquisition unit to acquire a character string which includes a masked portion; a word sequence acquisition unit to segment the character string into words and acquires a word sequence including a plurality of words; a control information acquisition unit to acquire an adjectival expression representing a nature or a state of a thing as a control word; and an inference unit to infer a likely candidate word for the masked portion from the control word and the word sequence and output the character string in which the masked portion is replaced with the likely candidate word.

### CROSS REFERENCE TO RELATED APPLICATION

This application is a Continuation of PCT International Application No. PCT/JP2023/018368, filed on May 17, 2023, which is hereby expressly incorporated by reference into the present application.

### TECHNICAL FIELD

The present disclosure relates to an inference device, a learning device, an inference method, a method for generating a trained model, an inference program, and a learning program.

### BACKGROUND TECHNOLOGY

In recent years, language models using Artificial Intelligence (AI) have achieved remarkable improvements in accuracy; for example, in Patent Document 1, a language model with an attention-based sequence transformation network has been proposed.

### PRIOR ART REFERENCES

### Patent Documents

[Patent Document 1] Japanese Patent No. 6884871

### SUMMARY OF THE INVENTION

### Problems to be Solved by the Invention

Learning a language model requires a large amount of text data. However, if the data is randomly collected and used for the learning, a sense of human discrimination with respect to race, gender, ethnicity, culture, and so on reflects against the language model, and thus, the inference device using the language model may generate an ethically inappropriate sentence.

The present disclosure is created to address the above problem and to obtain an inference device which generates ethically appropriate texts.

### Means to Solve the Problems

An inference device according to the present disclosure includes: a mask data acquisition unit to acquire a character string which includes a masked portion; a word sequence acquisition unit to segment the character string into words and acquires a word sequence including a plurality of words; a control information acquisition unit to acquire an adjectival expression representing a nature or a state of a thing as a control word; and an inference unit to infer a likely candidate word for the masked portion from the control word and the word sequence and output the character string in which the masked portion is replaced with the likely candidate word.

### Effects of the Invention

The inference device according to the present disclosure includes the control information acquisition unit to acquire the adjectival expression representing a nature or a state of a thing as the control word; and the inference unit to infer the likely candidate word for the masked portion from the control word and the word sequence and output the character string in which the masked portion is replaced with the likely candidate word, so that an ethically appropriate sentence can be generated by inferring the likely candidate word on the basis of the control word.

### BRIEF DESCRIPTION OF THE DRAWINGS

FIG. 1 is a diagram showing a configuration of a language processing system 10 according to Embodiment 1.

FIG. 2 is a diagram showing a configuration of a learning device 100 according to Embodiment 1.

FIG. 3 is a conceptual diagram showing a concrete example of processing of a morpheme analysis unit 121 according to Embodiment 1.

FIG. 4 is a conceptual diagram showing a concrete example of processing of a lexicalization unit 122 according to Embodiment 1.

FIG. 5 is a conceptual diagram showing an example of a word sequence.

FIG. 6 is a conceptual diagram showing an example of a trained model.

FIG. 7 is a conceptual diagram showing a concrete example of Adjectival Expression-Term PMI.

FIG. 8 is a diagram showing an example of a hardware configuration of a computer realizing the learning device 100 according to Embodiment 1.

FIG. 9 is a flowchart showing operation of the learning device 100 according to Embodiment 1.

FIG. 10 is a diagram showing a configuration of a language model storage device 300 according to Embodiment 1.

FIG. 11 is a diagram showing a configuration of an inference device 200 according to Embodiment 2.

FIG. 12 is a conceptual diagram showing a concrete example of a word sequence which includes a masked portion.

FIG. 13 is a conceptual diagram showing a concrete example of Forward N-gram likelihood.

FIG. 14 is a conceptual diagram showing a concrete example of Backward N-gram likelihood.

FIG. 15 is a conceptual diagram to illustrate a concrete example of processing in which a first inference unit 251 acquires pointwise mutual information using the trained model.

FIG. 16 is a diagram showing an example of a hardware configuration of a computer realizing the inference device 200 according to Embodiment 1.

FIG. 17 is a flowchart showing operation of the inference device 200 according to Embodiment 1.

FIG. 18 is a diagram showing a configuration of a language processing system 2010 according to Embodiment 2.

FIG. 19 is a diagram showing a configuration of a learning device 2100 according to Embodiment 2.

FIG. 20 is a conceptual diagram to illustrate a concrete example of processing of a bias removal unit according to Embodiment 2.

### EMBODIMENTS FOR CARRYING OUT THE INVENTION

### Embodiment 1

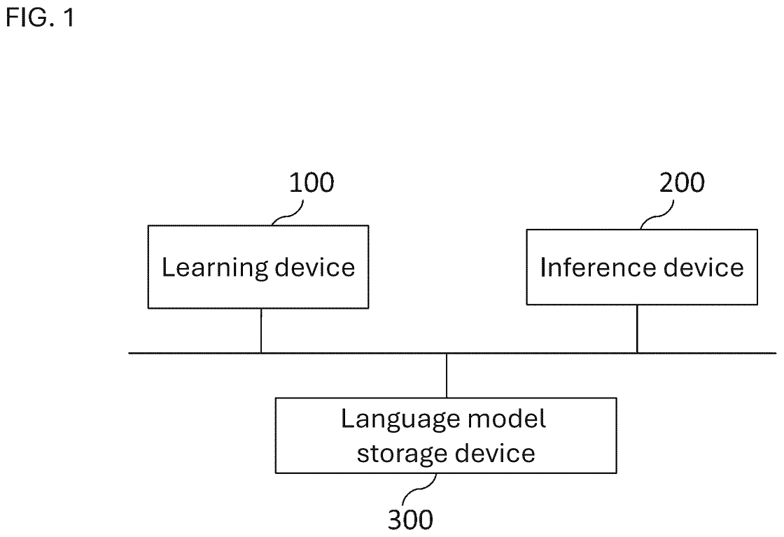

FIG. 1 is a diagram showing a configuration of a language processing system 10 according to Embodiment 1. The language processing system 10 includes a learning device 100, an inference device 200, and a language model storage device 300.

The language processing system 10 generates a sentence automatically and can be used, for example, for a chatbot or an automated voice response system. As described later, the language processing system 10 generates a sentence by inferring a word which fits in a masked portion in a character string which includes the masked portion. Here, a character string and a text are treated as synonymous.

First, a learning phase, in which the learning device 100 generates a trained model, will be described, and then, an inference phase, in which the inference device 200 makes inference using the trained model, will be described.

In the present disclosure, the trained model refers to an Adjectival expression-Term PMI (pointwise mutual information) model, which will be described later.

### <Learning Phase>

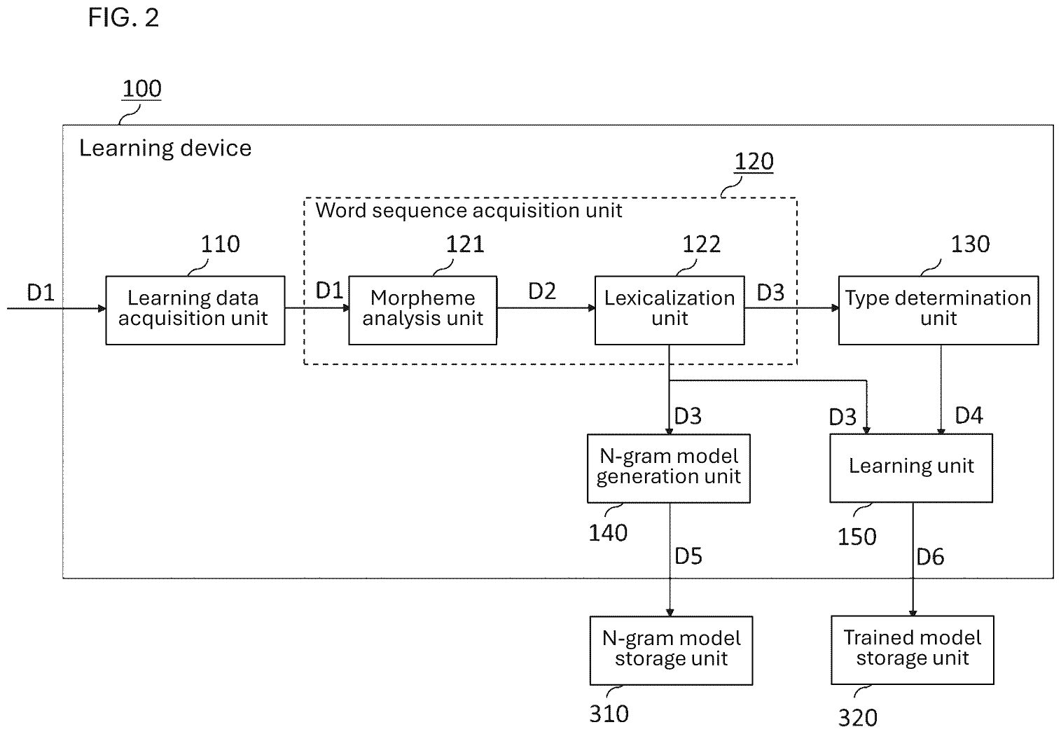

FIG. 2 is a diagram showing a configuration of the learning device 100 according to Embodiment 1. The learning device 100 includes a learning data acquisition unit 110, a word sequence acquisition unit 120, a type determination unit 130, an N-gram model generation unit 140, and a learning unit 150.

The learning data acquisition unit 110 acquires a character string D1 as training data included in a training data set. More specifically, the learning data acquisition unit 110 acquires a plurality of character strings by segmenting a text data into sentences, the text data being entered as the training data. That is, in the following, it is assumed that one character string corresponds to one sentence.

The training data set is stored in a storage device (not shown), and the learning data acquisition unit 110 acquires the training data from the storage device when the learning is performed.

The word sequence acquisition unit 120 segments the character string D1, acquired by the learning data acquisition unit 110, into words, and acquires a word sequence D3 including a plurality of words. The word sequence D3 here means a set of words with lexical category information attached.

Segmenting a character string into words includes not only segmenting a character string directly into words, but also segmenting a character string first into larger units such as phrases and then segmenting them into words, as well as segmenting a character string first into smaller units such as morphemes and then concatenating them to form words.

In Embodiment 1, the word sequence acquisition unit 120 includes a morpheme analysis unit 121 and a lexicalization unit 122.

The morpheme analysis unit 121 segments the character string D1, acquired by the learning data acquisition unit 110, into morphemes, which are grammatically minimum units, and acquires a morpheme sequence D2 including a plurality of morphemes with the lexical category information attached.

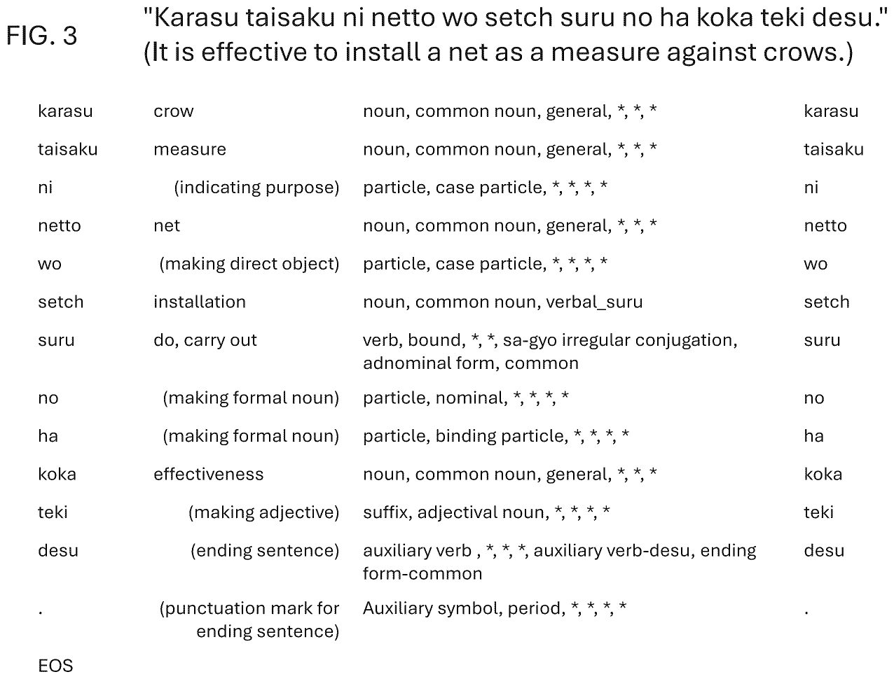

A concrete example of processing of the morpheme analysis unit 121 will be described using FIG. 3. FIG. 3 is a conceptual diagram showing a concrete example of the processing of the morpheme analysis unit 121. When a character string, for example, “Karasu taisaku ni netto wo setchi suru no ha koka teki desu.” (It is effective to install a net as a measure against crows.) is entered, the morpheme analysis unit 121 segments it into: “Karasu (crow)”, “taisaku (measure)”, “ni (particle)”, “netto (net)”, “wo (particle)”, “setchi (installation)”, “suru (do)”, “no (particle)”, “ha (particle)”, “koka (effectiveness)”, “teki (suffix)”, “desu (auxiliary verb)”, “. (auxiliary symbol)”. The lexical category information is attached in such a manner as noun for “karasu (crow)” and particle for “ni”. It is also possible to attach more detailed grammatical information, such as common noun and case particle. The UniDic classification, for example, can be used for the lexical category information. The UniDic is an electronic dictionary for texts in Japanese. An electronic dictionary other than the UniDic may be used if it is possible to attach the lexical category information similar to the UniDic.

The lexicalization unit 122 acquires the word sequence D3 by concatenating the morphemes included in the morpheme sequence D2 outputted by the morpheme analysis unit 121 on the basis of the lexical category information. The lexicalization refers to a process of generating a word by concatenating a preceding and a succeeding morpheme in a morpheme sequence. Because the UniDic employs a morphological unit, which is a linguistic unit defined with an emphasis on uniformity on the basis of a minimum unit, the lexicalization as described above is applied in order to handle word meanings.

In the following, a word shall be defined as consisting of one or more morphemes. In other words, this includes both a morpheme which is not concatenated but functions as a word, and a concatenation of morphemes to function as a word.

The following is a detailed description of processing of the lexicalization unit 122. The lexicalization unit 122 receives the morpheme sequence outputted by the morpheme analysis unit 121, checks a lexical category of each morpheme, concatenates the morphemes which can be concatenated, and outputs the morpheme sequence which is lexicalized.

If a morpheme is preceded by a prefix morpheme or succeeded by a suffix morpheme, the lexicalization unit 122 concatenates the morphemes. The lexicalization unit 122 substitutes the lexical category of the rearmost concatenated morpheme for the lexical category of the morpheme obtained by the concatenation.

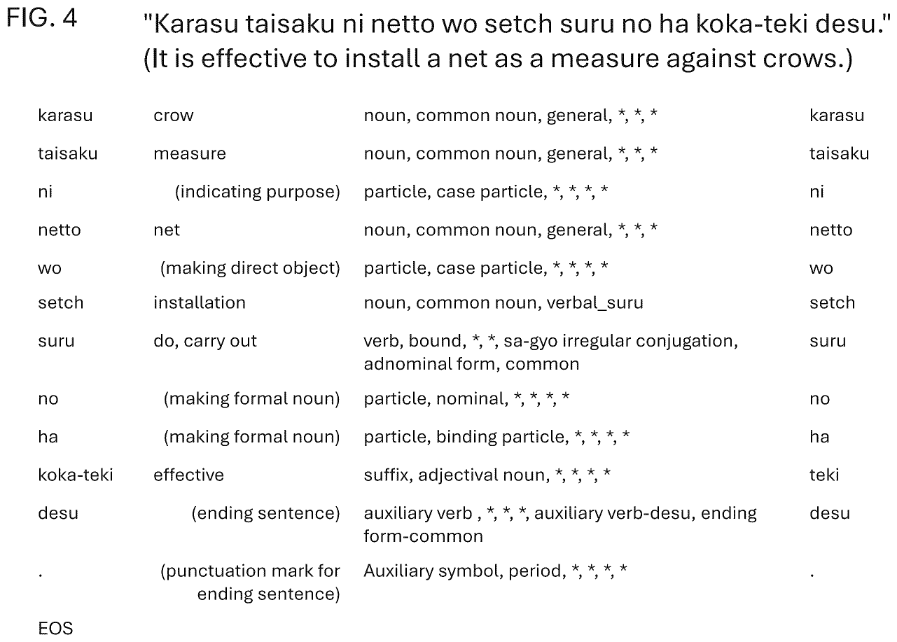

A concrete example of the processing of the lexicalization unit 122 will be described using FIG. 4. FIG. 4 is a conceptual diagram showing a concrete example of the processing of the lexicalization unit 122. For example, when a morpheme sequence described in FIG. 3, that is, “Karasu taisaku ni netto wo setchi suru no ha koka teki desu.” (It is effective to install a net as a measure against crows.) is entered, the lexicalization unit 122 concatenates “koka (effectiveness)” preceding “teki (suffix)” and “teki (suffix)” to generate a vocabulary “koka-teki (effective, suffix)”, because the lexical category of “teki” is suffix.

As another example, when the morpheme analysis is performed for a character string, “Karasu taisaku ni netto wo setchi suru no ha hi koka teki desu.” (It is ineffective to install a net as a measure against crows.), the character string is first segmented into morphemes, “Karasu (crow)”, “taisaku (measure)”, “ni (particle)”, “netto (net)”, “wo (particle)”, “setchi (installation)”, “suru (do)”, “no (particle)”, “ha (particle)”, “hi (prefix)”, “koka (effectiveness)”, “teki (suffix)”, “desu (auxiliary verb)”, “. (auxiliary symbol)” by the morpheme analysis unit 121.

The lexicalization unit 122 concatenates “koka (effectiveness)” succeeding “hi (prefix)” and “hi (prefix)” to obtain “hi-koka (ineffectiveness)” because “hi” is prefix, and further concatenates “hi-koka (ineffectiveness)” and “teki (suffix)” to generate a word “hi-koka-teki (ineffective, suffix)”.

The type determination unit 130 determines a sentence type D4 indicated by the word sequence D3 acquired by the word sequence acquisition unit 120. The type determination unit 130 outputs the determined sentence type D4 to the learning unit 150. The sentence type D4, which is used here to classify a sentence, is either an affirmative sentence, a negative sentence, or an interrogative sentence.

The following is a detailed description of processing of the type determination unit 130. The type determination unit 130 determines the sentence type in accordance with the following rules on the basis of the lexical category information and the notation of the words included in a word sequence. When a sentence ends with “? (auxiliary symbol)”, the sentence type is determined as an interrogative sentence. When the last word in a sentence, except for an auxiliary symbol at the end of the sentence, is “nai (particle),” the type of the sentence is determined as a negative sentence. The sentence type other than the above is determined as an affirmative sentence.

The type determination unit 130 may use another existing determination method. For example, as a method for determining a negative sentence, an automatic detection method of a negative element and a focus of negation in a sentence may be used. The determination of whether a sentence is an interrogative sentence may be based on whether an expression which is often used in interrogative sentences, such as “kana”, “kane”, “ka”, “noka” or “daroka”, which are particles to end sentences, is used at the end of the sentence.

The N-gram model generation unit 140 generates an N-gram model D5 on the basis of the word sequence D3 acquired by the word sequence acquisition unit 120. The N-gram model generation unit 140 outputs the generated N-gram model D5 to an N-gram model storage unit 310 included in the language model storage device 300.

The N-gram model is a language model in which occurrence probability of each word depends only on the N−1 words immediately before or after the word in question.

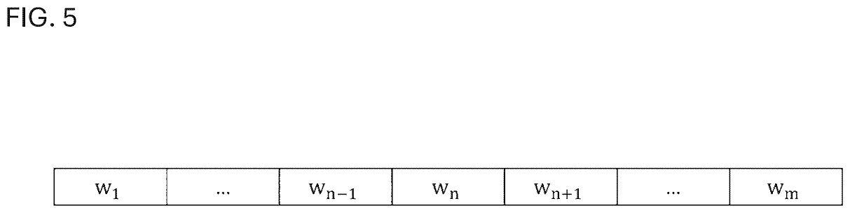

In the word sequence including m words as shown in FIG. 5, the N-gram model generation unit 140 calculates Forward N-gram likelihood for an N-gram of a word wᵢ, “w_{i-N+1}, . . . , wᵢ₋₁, wᵢ”, using the following Expression.

$$Forward N - gram likelihood = {log}_{2} ( P ( {w}_{i} \vert {w}_{i - N + 1}^{i - 1} ) ) \qquad [ Equation 1 ]$$

The N-gram model generation unit 140 calculates Backward N-gram likelihood for an N-gram, “wᵢ, wᵢ₊₁, . . . , w_{i+N-1}”, which is in backward order from the end of a sentence using the following Expression.

$$Backward N - gram likelihood = {log}_{2} ( P ( {w}_{i} \vert {w}_{i + N - 1}^{i + 1} ) ) \qquad [ Equation 2 ]$$

The N-gram model generation unit 140 generates an N-gram model by storing a pair of the N-gram “w_{i-N+1}, . . . , wᵢ₋₁, wᵢ” and the corresponding Forward N-gram likelihood as well as a pair of the N-gram “wᵢ, wᵢ₊₁, . . . , w_{i+N-1}” and the corresponding Backward N-gram likelihood. In the following, the log likelihoods obtained from the N-gram model, i.e., the Forward N-gram likelihood and the Backward N-gram likelihood, are collectively referred to as the N-gram likelihood.

The learning unit 150 generates a trained model D6, which receives an adjectival expression representing a nature or a state of a thing and two words to output the pointwise mutual information between the adjectival expression and the two words, on the basis of the occurrence probabilities in the training data set for leaning words included in the word sequence D3.

More specifically, the learning unit 150 generates the trained model D6 on the basis of the occurrence probability, in the training data set, of a first word, which is an adjectival expression included in the word sequence D3, the occurrence probability, in the training data set, of a second word included in the word sequence D3, the occurrence probability, in the training data set, of a third word included in the word sequence D3, as well as a probability of simultaneous occurrence, in the training data set, of the first word, the second word, and the third word.

The adjectival expression is either an adjective, an adjective verb, or an adjectival noun. Here, the adjectival noun refers to a noun which is turned into an adjective verb when followed by “na” (an adnominal form of an auxiliary verb “da”) as in “anzen (na)” and “shimpai (na)”, which mean “safe” and “worrisome”, respectively. According to the UniDic classification, the adjectival expression can be classified into either an adjective, an adjectival_noun, a noun (common.adjectival), a noun (common.verbal.adjectival), a suffix (nominal.adjectival), a suffix (adjectival_noun), or a suffix (adjective_i).

Also, in Embodiment 1, the learning unit 150 generate the trained model D6 which receives the sentence type in addition to the adjectival expression and the two words and outputs the pointwise mutual information.

More specifically, the learning unit 150 generates a fourth-order tensor as the trained model D6, which receives the sentence type determined by the type determination unit, the adjectival expression, and the two words, and outputs the pointwise mutual information between the adjectival expression and the two words.

The following is a detailed description of processing of tensor learning performed by the learning unit 150. First, the learning unit 150 classifies the word sequence D3 by the sentence type D4. Then, the learning unit 150 counts the total number of words Z and the number of occurrence c (w) for each word w, for each sentence type D4.

Then, the learning unit 150 counts the numbers of simultaneous occurrences, c (A, wₓ, w_{y}) and c (A, w_{y}, wₓ), with respect to an adjectival expression A and words wₓ and w_{y} for each sentence type D4. More precisely, the adjectival expression (A) and the two words (wₓ, w_{y}) are extracted arbitrarily from each word sequence, and the number of occurrences is incremented by one for each occurrence of a word order (A, wₓ, w_{y}) and a word order (A, w_{y}, wₓ). This processing is to be performed for all of the word sequences. Here, an occurrence of words in backward order is also added to make the tensor robust against the sparseness. However, as described later, an occurrence of words in backward order may not be added and an asymmetric tensor may be generated. A word which appears more than once in a word sequence may be counted only once, and a diagonal component for which wₓ=w_{y} may be treated differently from a non-diagonal component depending on purposes.

Then, the learning unit 150 calculates an Adjectival Expression-Term PMI value (the pointwise mutual information) for each of the stored triplets of A, wₓ and w_{y} using Expressions 3 through 7.

$$P ( A ) = \frac{c ( A )}{Z} \qquad [ Equation 3 ]$$

$$P ( {w}_{x} ) = \frac{c ( {w}_{x} )}{Z} \qquad [ Equation 4 ]$$

$$P ( {w}_{y} ) = \frac{c ( {w}_{y} )}{Z} \qquad [ Equation 5 ]$$

$$PMI ( A , {w}_{x} , {w}_{y} ) = {log}_{2} \frac{P ( A , {w}_{x} , {w}_{y} )}{P ( A ) P ( {w}_{x} ) P ( {w}_{y} )} \qquad [ Equation 6 ]$$

$$\text{?} \qquad [ Equation 7 ]$$

$$\text{?} \text{indicates text missing or illegible when filed}$$

Here, w=A is the first word of the adjectival expression, w=wₓ is the second word, w=w_{y} is the third word, and P(A), P (wₓ), P(w_{y}) and P(A, wₓ, w_{y}) are their respective occurrence probabilities. However, when no triplet of A, wₓ, w_{y} occurs or when the PMI (A, wₓ, w_{y}) is negative, 0 is substituted for the PMI (A, wₓ, w_{y}) to be stored.

Finally, the learning unit 150 generates the trained model D6 by integrating the Adjectival Expression-Term PMI values of the triplets for each sentence type D4 into one fourth-order tensor on the basis of Equation 8.

$$PMI ( G , A , {w}_{x} , {w}_{y} ) = {log}_{2} \frac{P ( G , A , {w}_{x} , {w}_{y} )}{P ( G , A ) P ( G , {w}_{x} ) P ( G , {w}_{y} )} \qquad [ Equation 8 ]$$

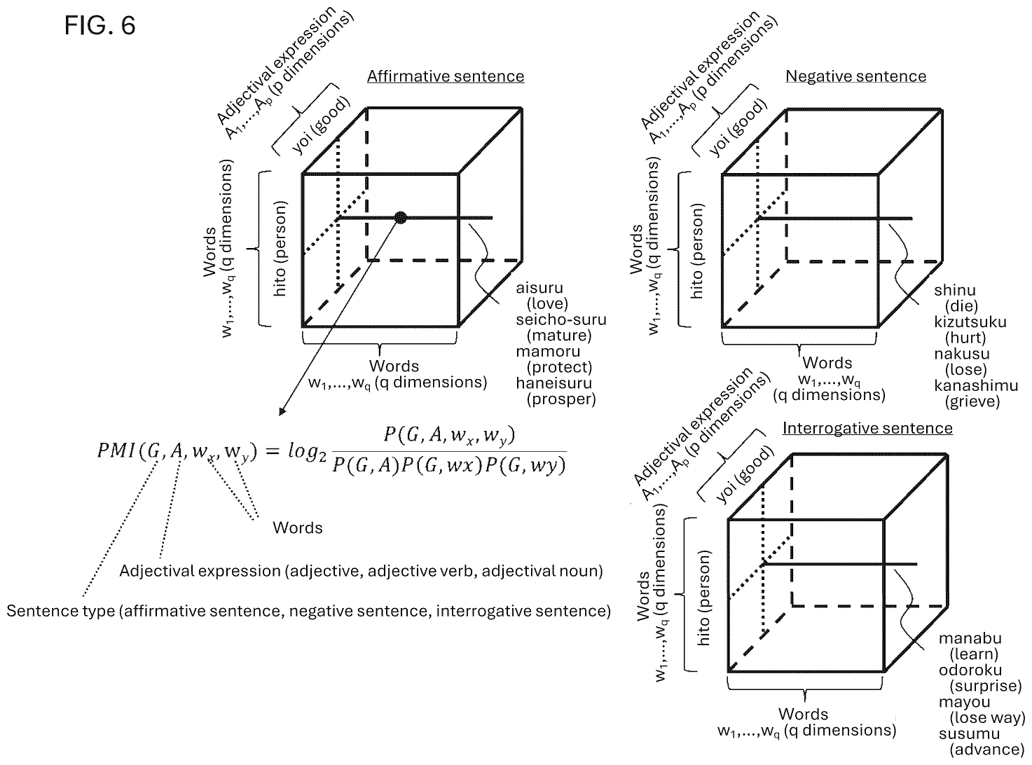

FIG. 6 is a conceptual diagram showing an example of the generated trained model. In FIG. 6, due to constraints of representation on the paper, the fourth-order tensor is represented as three cuboids, and the pointwise mutual information is given at each point of the cuboids designated by the sentence type and the three words. The dimension of the sentence type G (the first argument) is 3, the dimension of the adjectival expression A (the second argument) is p, and the dimensions of the words wₓ (the third argument) and w_{y} (the fourth argument) are q. Both p and q are positive integers, where p is the number of adjectival expressions in the word dictionary (the vocabulary size of the adjectival expressions) and q is the number of all words in the word dictionary (the entire vocabulary size).

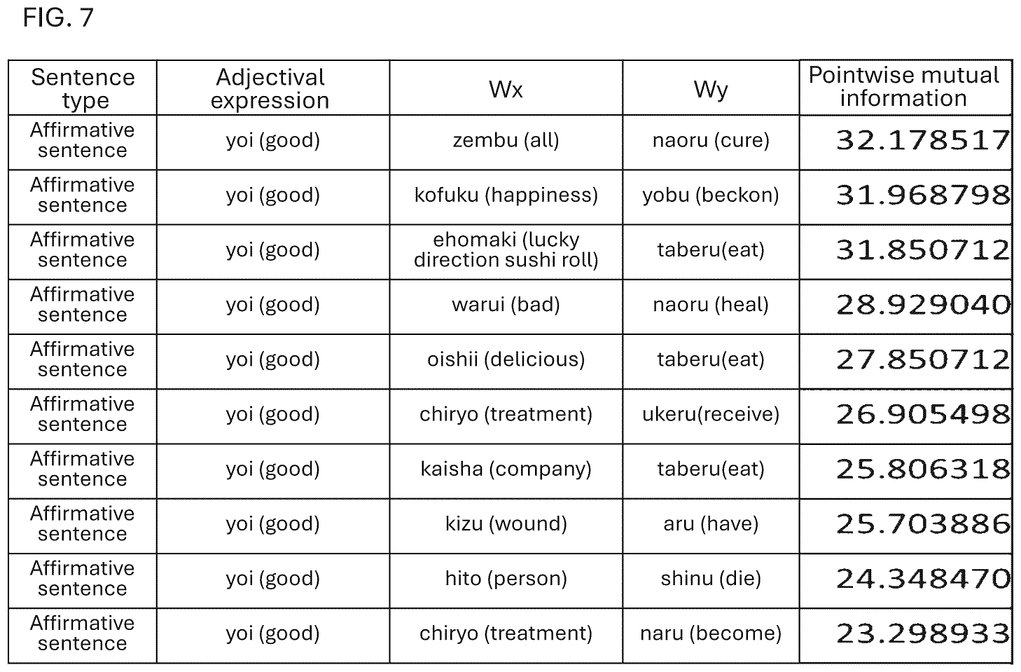

Here, for example, in the case where the sentence type is “affirmative sentence”, the adjectival expression A is “yoi (good)”, and the word wₓ is “hito (person)”, when, as w_{y}, a word which is highly related to “hito (person)” and “yoi (good)” is entered, such as “aisuru (love)”, “seicho-suru (mature)”, “mamoru (protect)”, and “hanei-suru (prosper)”, then, PMI (G, A, wₓ, w_{y}) takes a large value. Also, for example, in the case where the sentence type is “negative sentence”, the adjectival expression A is “yoi (good)”, and the word wₓ is “hito (person)”, when, as w_{y}, a word such as “shinu (die)”, “kizutsuku (hurt)”, “nakusu (lose)”, and “kanashimu (grieve)” is entered, then, PMI (G, A, wₓ, w_{y}) takes a large value. Furthermore, for example, in the case where the sentence type is “affirmative sentence” and the adjectival expression A is “yoi (good)”, when a pair of words, such as “zembu (all)” and “naoru (cure)”, “kofuku (happiness)” and “yobu (beckon)”, and “warui (bad) and “naoru (heal)”, is entered for the words wₓ and w_{y}, then, PMI (G, A, wₓ, w_{y}) takes a large value. In addition, for example, in the case where the sentence type is “affirmative sentence” and the adjectival expression A is “yoi (good)”, when a pair of words, such as “kizu (wound)” and “aru (have)”, “hito (person)” and “shinu (die)”, and “chiryo (treatment) and “naru (undergo)”, is entered for the words wₓ and w_{y}, then, PMI (G, A, wₓ, w_{y}) takes a small value. Thus, by being able to calculate the pointwise mutual information with respect to “yoi (good)” on the basis not only of a single word but also of a pair of words, the likelihood according to the context of an inputted sentence can be calculated precisely. The training sample for the pointwise mutual information calculated by Equation 8 is shown in FIG. 7.

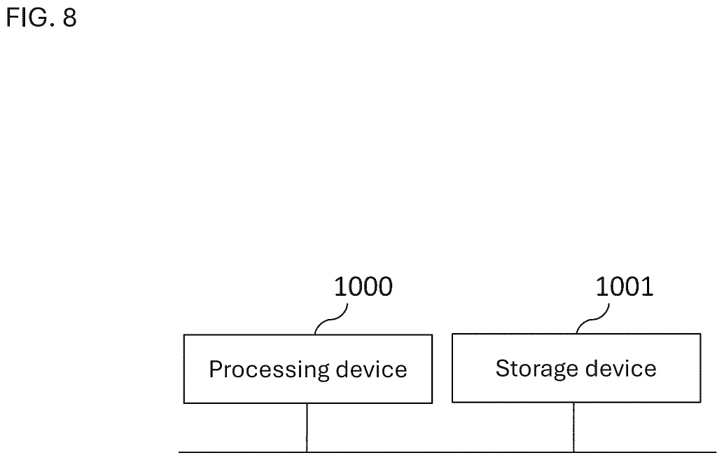

Next, a hardware configuration of the learning device 100 according to Embodiment 1 will be described. Each of the functions of the learning device 100 is realized by a computer. FIG. 8 is a diagram showing an example of the hardware configuration of the computer realizing the learning device 100 according to Embodiment 1.

The hardware shown in FIG. 8 includes a processing device 1000 such as a central processing unit (CPU) and a storage device 1001 such as a read only memory (ROM) and a hard disk.

The learning data acquisition unit 110, the word sequence acquisition unit 120, the type determination unit 130, the N-gram model generation unit 140, and the learning unit 150, shown in FIG. 2, are realized by a program stored in the storage device 1001 being executed by the processing device 1000. The above configuration is not limited to a configuration realized by a single processing device 1000 and a single storage device 1001, but may be realized by a plurality of processing devices 1000 and storage devices 1001.

The method of realizing each function of the learning device 100 is not limited to those performed by a combination of hardware and a program described above, but may be realized by hardware alone such as a large scale integrated circuit (LSI) in which a program is implemented in a processing device. Alternatively, a configuration is also possible in which some of the functions are realized by dedicated hardware and remaining functions are realized by a combination of a processing device and a program.

The learning device 100 according to Embodiment 1 is configured as described above.

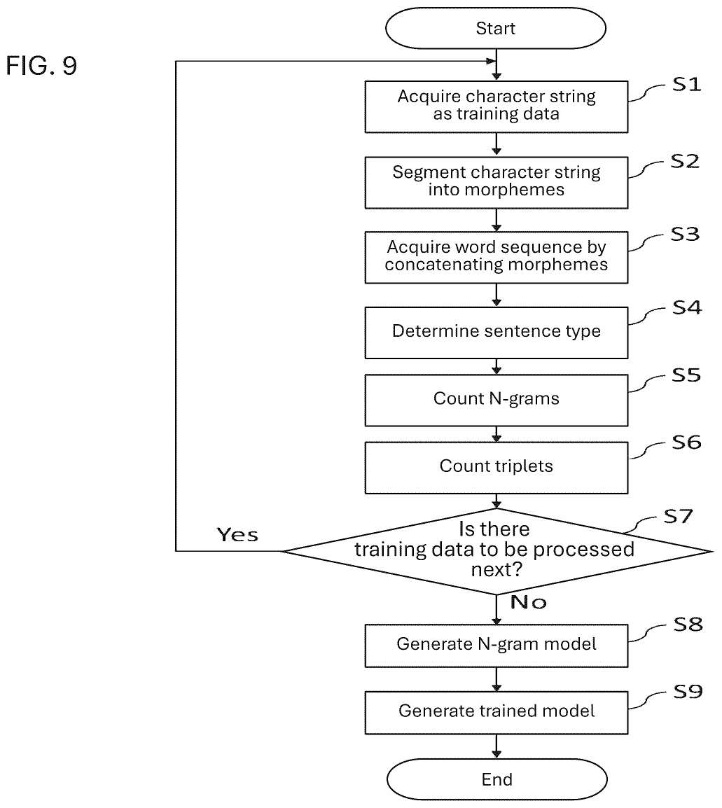

Operation of the learning device 100 according to Embodiment 1 will be described next. FIG. 9 is a flowchart showing the operation of the learning device 100 according to Embodiment 1. The operation of the learning device 100 corresponds to a generation method of the trained model, and the program which causes a computer to perform the operation of the learning device 100 corresponds to a learning program.

The operation of the learning data acquisition unit 110 corresponds to a learning data acquisition process, the operation of the word sequence acquisition unit 120 corresponds to a word sequence acquisition process, the operation of the type determination unit 130 corresponds to a type determination process, the operation of the N-gram model generation unit 140 corresponds to an N-gram model generation process, and the operation of the learning unit 150 corresponds to a learning process.

First, in step S1, the learning data acquisition unit 110 acquires the character string D1 as the training data included in the training data set.

Next, in step S2, the morpheme analysis unit 121 segments the character string D1, acquired by the learning data acquisition unit 110 in step S1, into morphemes, which are grammatically minimum units, and acquires the morpheme sequence D2, which includes the plurality of morphemes with the lexical category information attached.

Next, in step S3, the lexicalization unit 122 acquires the word sequence D3 by concatenating the morphemes included in the morpheme sequence D2 acquired by the morpheme analysis unit 121 in step S2 on the basis of the lexical category information.

Next, in step S4, the type determination unit 130 determines the sentence type D4 indicated by the word sequence D3 on the basis of the lexical category information and the notation of the words included in the word sequence D3 acquired by the word sequence acquisition unit 120.

Then, in step S5, the N-gram model generation unit 140 counts the number of occurrences of the word sequence of N-gram included in the word sequence D3 acquired by the word sequence acquisition unit 120.

Then, in step S6, the learning unit 150 counts the number of occurrences of each word included in the word sequence D3 and the number of occurrences of the triplet of the adjectival expression and the other two extracted words included in the word sequence D3.

Next, in step S7, the learning data acquisition unit 110 determines whether there is training data to be processed next in the training data set. When the learning data acquisition unit 110 determines that there is data to be processed next, the process returns to step S1 to acquire the next training data, and when it determines that there is no data to be processed next, the process proceeds to step S8 for the N-gram model generation unit 140 to generate the N-gram model D5 and proceeds further to step S9 for the learning unit 150 to generate the trained model D6.

In step S8, the N-gram model generation unit 140 calculates the Forward N-gram likelihood and the Backward N-gram likelihood for each N-gram on the basis of the number of occurrences of the word sequence of the N-gram counted in step S5, and generates the N-gram model D5 by storing the association of each N-gram with the Forward N-gram likelihood and the Backward N-gram likelihood.

In step S9, the learning unit 150 calculates the occurrence probability of each word and the occurrence probability of each triplet on the basis of the number of occurrences of each word and the number of occurrences of each triplet counted in step S6. Then, the learning unit 150 generates the trained model D6 by calculating the pointwise mutual information for each triplet on the basis of the occurrence probabilities of each word and each triplet and storing the association of the sentence type, the triplets, and the pointwise mutual information.

By performing the above operation, the learning device 100 according to Embodiment 1 can obtain a trained model capable of inferring a likely candidate word having large pointwise mutual information with the adjectival expression having a good meaning and thus being ethically appropriate because the trained model is configured to receive an adjectival expression representing a nature or a state of a thing and two words and output the pointwise mutual information between the adjectival expression and the two words. By using such a trained model, an ethically appropriate sentence can be created.

In addition, the learning device 100 according to Embodiment 1 can obtain a trained model capable of inferring the likely candidate word more accurately by outputting the pointwise mutual information for each sentence type, because the sentence type indicated by the word sequence is determined and the trained model is configured to receive the sentence type in addition to the adjectival expression and the two words and output the pointwise mutual information.

Furthermore, the learning device 100 according to Embodiment 1 segments a character string into morphemes, which are grammatically minimum units, acquires a morpheme sequence, which includes a plurality of morphemes with lexical category information attached, concatenates the morphemes included in the morpheme sequence on the basis of the lexical category information, and acquires a word sequence. Therefore, by generating a word which summarizes the meanings of the morphemes, a trained model which can infer the likely candidate word more accurately can be generated.

For example, if “koka (effectiveness)” and “teki (suffix)” are processed separately, it may happen that “teki (suffix)” is determined as an adjectival expression and the pointwise mutual information with respect to “teki (suffix)” is learned, because “koka (effectiveness)” is a noun and “teki” is a suffix of adjectival_noun. In contrast, when “koka (effectiveness)” and “teki (suffix)” are concatenated as “koka-teki (adjectival_noun-suffix)” to be processed as a single word, the pointwise mutual information can be learned for the word whose meaning is easier for humans to understand. The pointwise mutual information of antonyms can be learned properly by concatenating a prefix, such as “fu” and “hi”, with a succeeding morpheme to process them.

### <Inference Phase>

Next, an inference phase to generate a sentence by using the trained model (an Adjectival Expression-Term PMI model) generated in the learning phase will be described.

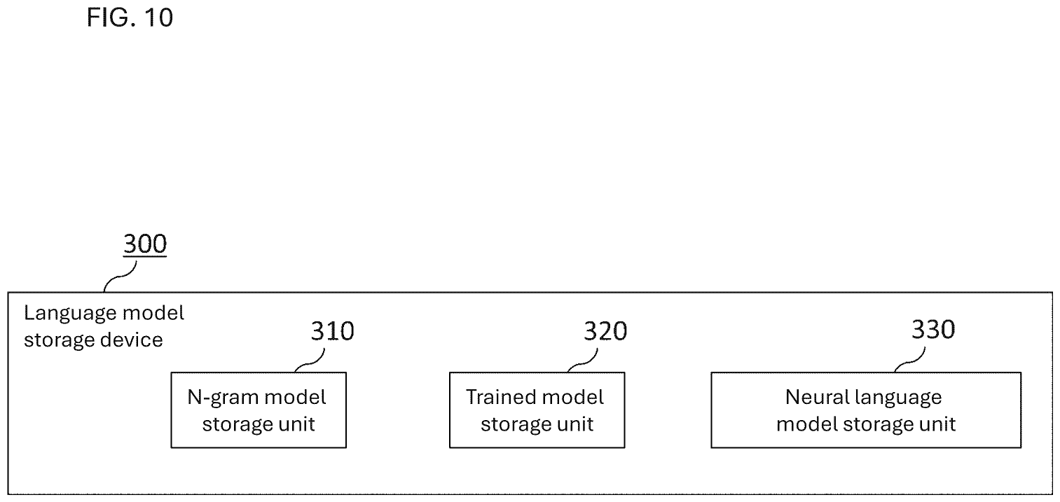

First, before describing the inference device 200, the language model storage device 300 will be described. FIG. 10 is a diagram showing a configuration of the language model storage device 300 according to Embodiment 1. The language model storage device 300 includes the N-gram model storage unit 310, a trained model storage unit 320, and a neural language model storage unit 330.

The N-gram model storage unit 310 stores an N-gram model generated by the N-gram model generation unit 140.

The trained model storage unit 320 stores the trained model generated by the learning unit 150.

The neural language model storage unit 330 stores a neural language model generated by a learning device (not shown) which is different from the learning device 100. The details of the neural language model will be described later.

The language model storage device 300 is realized by a storage device such as a read only memory (ROM) and a hard disk. The language model storage device 300 may be realized by a single server, by a plurality of servers distributed in a cloud, or as part of an edge-based storage. For example, when the language processing system 10 is used for an automated response system of a robot, the models may be stored in a server which collectively manages the robot or in the robot itself.

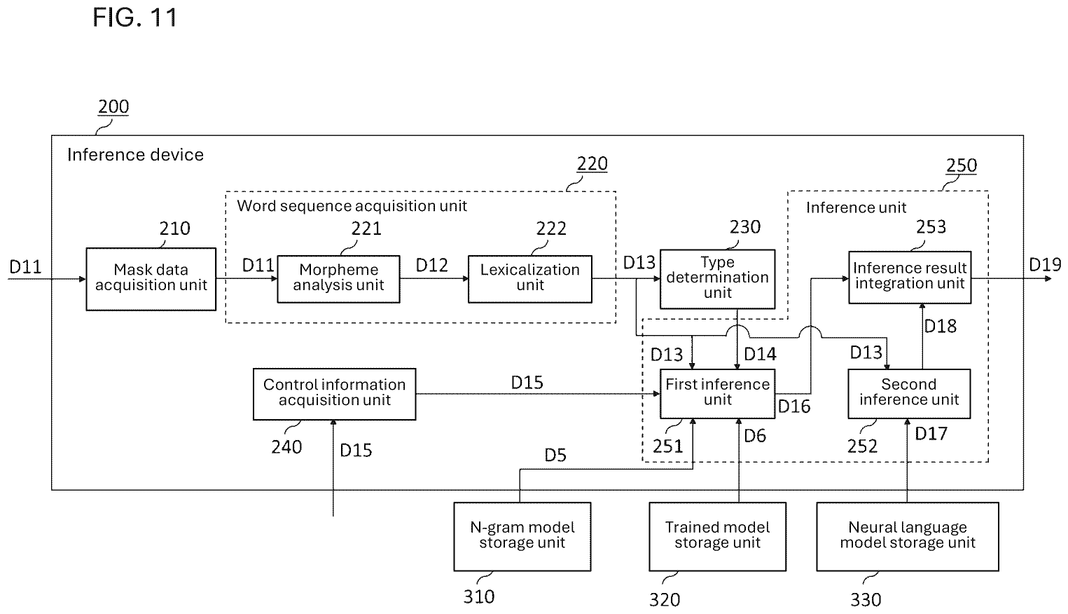

The inference device 200 will be described next. FIG. 11 is a diagram showing a configuration of the inference device 200 according to Embodiment 1. The inference device 200 includes a mask data acquisition unit 210, a word sequence acquisition unit 220, a type determination unit 230, a control information acquisition unit 240, and an inference unit 250.

The mask data acquisition unit 210 acquires a character string D11 which includes a masked portion. Here, the masked portion refers to a portion in a character string where a word to be placed there is missing and is replaced with a special word [MASK]. A word which can replace the special word [MASK] is the inference target of the inference device 200. The mask data is a text data of the character string D11 which includes the masked portion.

The word sequence acquisition unit 220 segments the character string D11, acquired by the mask data acquisition unit 210, into words, and acquires a word sequence D13 including a plurality of words, which is a process similar to the process performed by the word sequence acquisition unit 120 of the learning device 100.

The word sequence acquisition unit 220 includes a morpheme analysis unit 221 and a lexicalization unit 222.

The morpheme analysis unit 221 segments the character string D11, acquired by the mask data acquisition unit 210, into morphemes, which are grammatically minimum units, and acquires a morpheme sequence D12, which includes a plurality of morphemes with the lexical category information attached, which is a process similar to the process performed by the morpheme analysis unit 121.

The lexicalization unit 222 concatenates the morphemes included in the morpheme sequence on the basis of the lexical category information and acquires the word sequence D13, which is a process similar to the process performed by the lexicalization unit 122.

The type determination unit 230 determines a sentence type D14 indicated by a word sequence 13, which is a process similar to the process performed by the type determination unit 130 of the learning device 100.

The control information acquisition unit 240 acquires a control information D15 through user input. More specifically, the control information acquisition unit 240 acquires the adjectival expression representing a nature or a state of a thing as a control word, as well as weighting factors of the pointwise mutual information and the N-gram likelihoods as control intensities. The weighting factors of the pointwise mutual information and the N-gram likelihoods can be understood as the weighting factors for the Adjectival Expression-Term PMI model and the N-gram model.

The control information acquisition unit 240 acquires the control information D15 through an input via an input device (not shown) such as a keyboard or a touch panel from a user or a designer of the language processing system 10. The input from a user or a designer may be made when the inference is performed, or the control information D15 inputted and stored in advance may be read out when the inference is performed.

The control intensity may be set for each of the sentence types. For example, the control intensity may be set to 0.8 for an affirmative sentence, 0.2 for a negative sentence, and 0.5 for an interrogative sentence, with a greater value set for the affirmative sentence, a smaller value set for the negative sentence, and an intermediate value set for the interrogative sentence.

The inference unit 250 infers the likely candidate word for the masked portion and outputs a character string D19 in which the masked portion is replaced with the inferred likely candidate word. The inference unit 250 includes a first inference unit 251, a second inference unit 252, and an inference result integration unit 253. As described later, in Embodiment 1, the inference unit 250 infers the likely candidate word for the masked portion from the control word acquired by a control information acquisition unit 240 and the word sequence D13 acquired by the word sequence acquisition unit 220.

The inference unit 250 outputs the character string in which the masked portion is replaced with the inferred likely candidate word to a display or a speaker to communicate the character string, i.e. the generated text to the user.

The first inference unit 251, the second inference unit 252, and the inference result integration unit 253, which are included in the inference unit 250, will be described below.

The first inference unit 251 infers candidate words for the masked portion from the control word acquired by the control information acquisition unit 240 and the word sequence D13 acquired by the word sequence acquisition unit 220.

More specifically, the first inference unit 251 infers the candidate words by using the trained model which receives the control word, the words included in the word sequence, and candidate words, and outputs the pointwise mutual information of the control word, the words in included in the word sequence, and the candidate words.

The first inference unit 251 also infers the candidate words by using the pointwise mutual information obtained from the trained model and the N-gram likelihoods obtained from the N-gram model.

For example, when the length of the word sequence is m and the masked portion is the n-th word in the word sequence, the first inference unit 251 can infer the candidate words according to Equation 9 below.
α is the control intensity and β is the flooring coefficient.

$$= arg \text{} {max}_{W} \text{} \text{} ( \text{} ( 1 - α ) \text{} ( β + {\sum }_{i = 1}^{n} log ( P ( {w}_{i} \vert {w}_{i - N + 1}^{i - 1} ) ) + {\sum }_{i = m}^{n} log ( P ( {w}_{i} \vert {w}_{i + N - 1}^{i + 1} ) ) ) + α {\sum }_{i = 1}^{m} PMI ( G , A , {w}_{i} , {w}_{n} ) ) \qquad [ Equation 9 ]$$

The following is a detailed description of processing of the first inference unit 251. If Equation 9 is used as it is, the candidate words are narrowed down to one, but in the following processing, the first inference unit 251 shall select a plurality of the candidate words with the highest likelihoods in the argmax function of Equation 9 from the top, and output the selected set of the plurality of candidate words to the inference result integration unit 253 as a first candidate word group D16.

First, the first inference unit 251 acquires the sentence type D14 from the type determination unit 230, the word sequence D13 from the word sequence acquisition unit 220, and the control information D15 (the control word and the control intensity) from the control information acquisition unit 240.

Next, the first inference unit 251 inserts N−1 special words [NULL], taking account of sentence-initial prefixation and sentence-final suffixation.

The first inference unit 251 finds the special word [MASK] from the word sequence and defines it as wₙ.

The first inference unit 251 takes out wₙ as well as N−1 words before and after wₙ as the words of the N-gram both in the forward direction and in the backward direction.

The first inference unit 251 determines a word which can be placed in the portion of [MASK] from the word dictionary and obtains the Forward N-gram likelihood and the Backward N-gram likelihood by using the N-gram model.

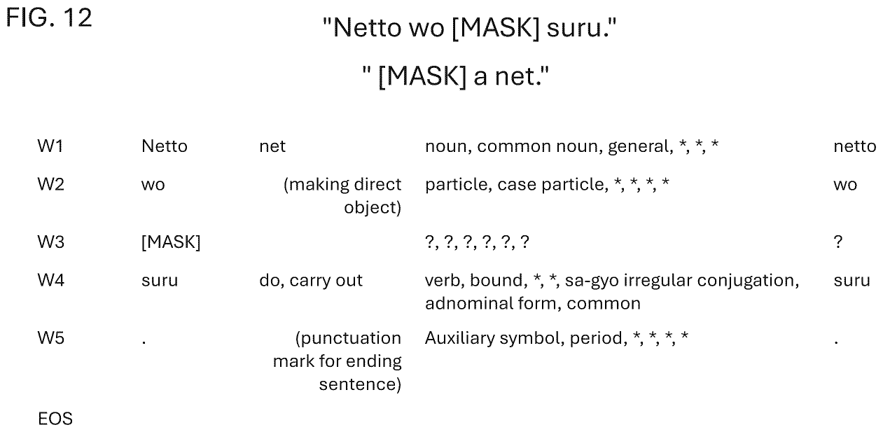

A concrete example of the processing of obtaining the N-gram likelihood from the N-gram model will be described using FIGS. 12 through 14. Here, N=3 for simplicity.

FIG. 12 is a conceptual diagram showing a concrete example of the word sequence including the masked portion. For example, assume that the words and the word sequence from which [MASK] is to be inferred are “netto (net)”, “wo (particle)”, “[MASK]”, “suru (do)”, “. (auxiliary symbol)”.

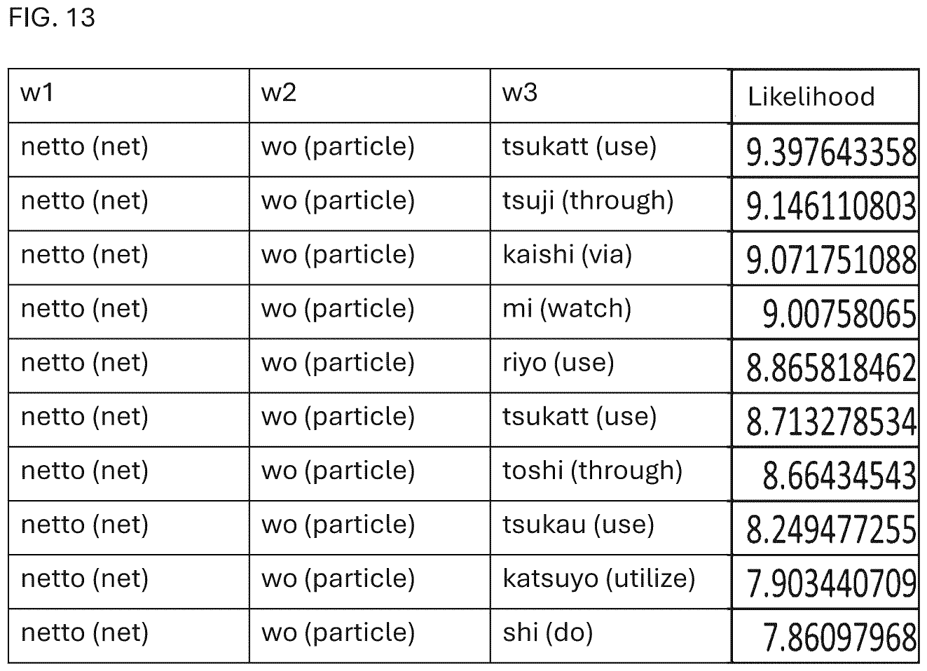

In this case, the forward N-grams are as shown in FIG. 13 in descending order of the Forward N-gram likelihood, where the likelihood of “tsukatt (use)” is obtained as 9.397643358 and the likelihood of “tsuji (through)” is obtained as 9.146110803, for example.

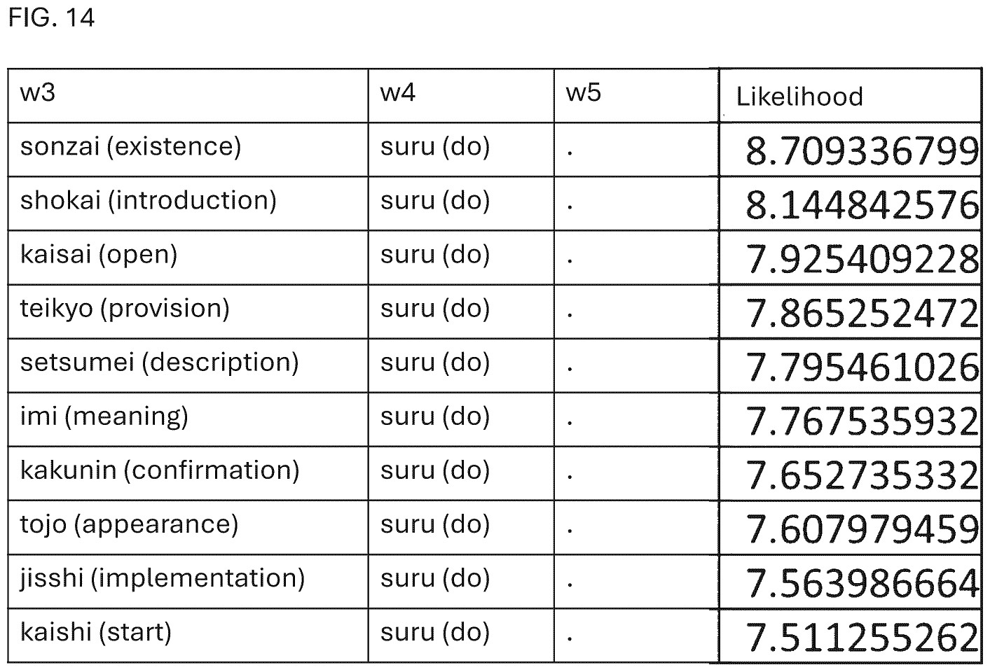

Similarly, the backward N-grams are as shown in FIG. 14 in descending order of the Backward N-gram likelihood, where the likelihood of “sonzai (existence)” is obtained as 8.709336799 and the likelihood of “shokai (introduction)” is obtained as 8.144842576, for example.

Next, the inference of the likely candidate word using the trained model will be described. The first inference unit 251 acquires the trained model D6 from the trained model storage unit 320.

The first inference unit 251 generates a triplet of words with the first word being the control word, the second word being a word included in the word sequence, and the third word being a word included in the word dictionary.

The first inference unit 251 obtains the pointwise mutual information of the generated triplet in the sentence type D14 by using the trained model.

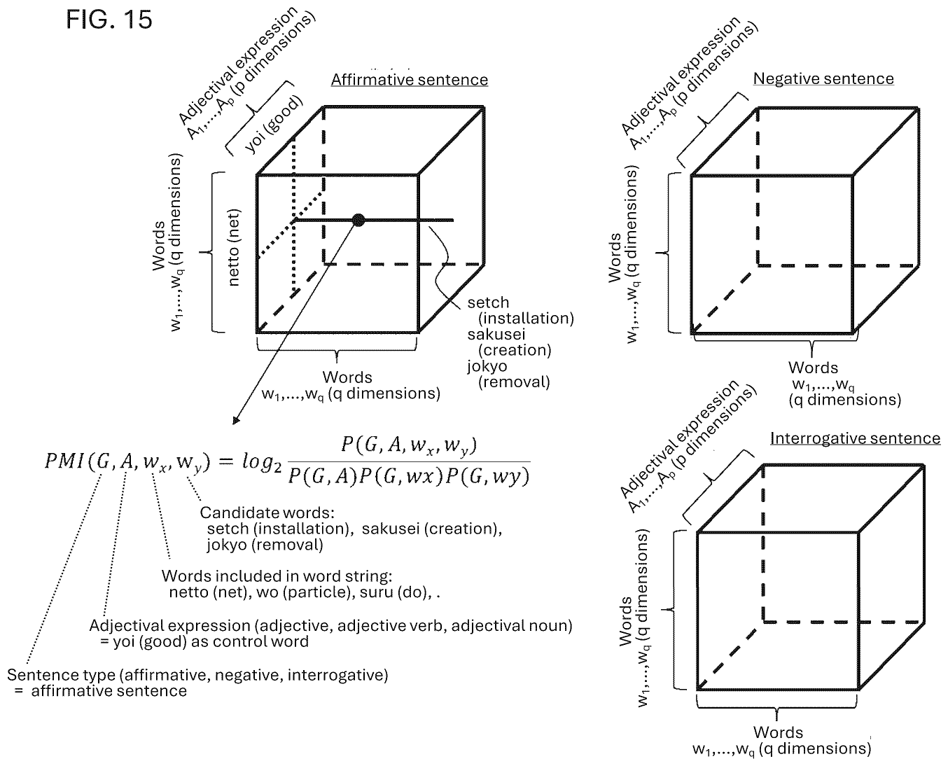

A concrete example of the processing of obtaining the pointwise mutual information from the trained model will be described using FIG. 15.

As in the case of the N-gram model, the word sequence in FIG. 12 is used as input in the description. Assume that “yoi (good)” is entered as the control word.

In this case, with the sentence type G being “affirmative sentence”, in addition to the adjectival expression A being “yoi (good)”, which is entered as the control word, and “netto (net)”, “wo (particle)”, “suru (do)”, “. (auxiliary symbol)”, which are entered for the word wₓ, further, words included in the word dictionary, such as “setchi (installation)”, “sakusei (creation)”, and “jokyo (removal)” are entered as the candidate words for w_{y}, and then, the pointwise mutual information is obtained for each of the inputs.

The first inference unit 251 calculates the N-gram likelihood and the pointwise mutual information for all words in the dictionary, and then, sorts the candidate words in descending order of the sum of the N-gram likelihoods and the pointwise mutual information (hereafter, the sum is referred to as the first likelihood).

The first inference unit 251 outputs the candidate words whose first likelihoods are greater than or equal to a predetermined threshold from among those sorted by the first likelihood to the inference result integration unit 253 as the first candidate word group D16.

The second inference unit 252 infers candidate words for the masked portion by using a neural language model D17. The neural language model is a language model using a neural network. As existing neural language models, for example, a language model using Recurrent Neural Network and a language model using Attention Mechanism such as Transformer and Bidirectional Encoder Representations from Transformers (BERT) are known.

Here, as an example, a case will be described in which the feedforward neural language model based on the feedforward neural network is used.

The feedforward neural language model predicts a next word by using a chain of N−1 words, which is similar to the N-gram model. If the n-th word is the masked portion, the words from the (n-N+1)-th to the (n−1)-th position are converted into a one-hot vector and fed into the feedforward neural network.

A linear transformation is applied to the vector outputted from the feedforward neural network to convert it into a vector with the same dimensions as the vocabulary size. Then, the converted vector is inputted into a softmax function.

The vector outputted from the softmax function above is a probability distribution of the n-th word, and each of the vector elements corresponds to the occurrence probability of each word in the dictionary.

Therefore, the candidate words for the masked portion can be inferred by performing a maximum likelihood estimation by using the vector outputted from the softmax function above.

Although the feedforward neural network is described here as an example, an existing neural language model may be used, including a language model using Recurrent Neural Network and a language model using Attention Mechanism such as Transformer and Bidirectional Encoder Representations from Transformers (BERT).

The second inference unit 252 outputs the candidate words whose likelihoods (hereinafter, referred to as the second likelihood) obtained from the neural language model are greater than or equal to a predetermined threshold from among the candidate words inferred by using the neural language model D17 to the inference result integration unit 253 as a second candidate word group D18.

The inference result integration unit 253 determines the likely candidate word included in common in both the first candidate word group D16, which is a set of the candidate words inferred by the first inference unit 251, and the second candidate word group D18, which is a set of the candidate words inferred by the second inference unit 252, as the word to replace the masked portion.

For example, if the candidate words included in the first candidate word group are “shokai (introduction)”, “setchi (installation)”, and “katsuyo (utilization)” and the candidate words included in the second candidate word group are “kogeki (attack)”, “hakai (destruction)”, and “setchi (installation)”, the inference result integration unit 253 determines that the word to be placed in the masked portion is “setchi (installation)”, because the word commonly included in the first candidate word group and the second candidate word group is “setchi (installation)”.

If there is more than one candidate word included in both the first candidate word group and the second candidate word group, a candidate word with the largest second likelihood in the second candidate word group may be determined as the likely candidate word to replace the masked portion from among the commonly included candidate words.

This is because the inferential accuracy of the neural language model is generally higher, so that the candidate words included in the second candidate word group are more likely to be contextually appropriate words, and among them, if a candidate word is also included in the first candidate word group, the word cannot be considered to be an ethically inappropriate word. In other words, the process performed in this case is equivalent to excluding ethically inappropriate words from the candidate words inferred by the neural language model by using the Adjectival Expression-Term PMI model.

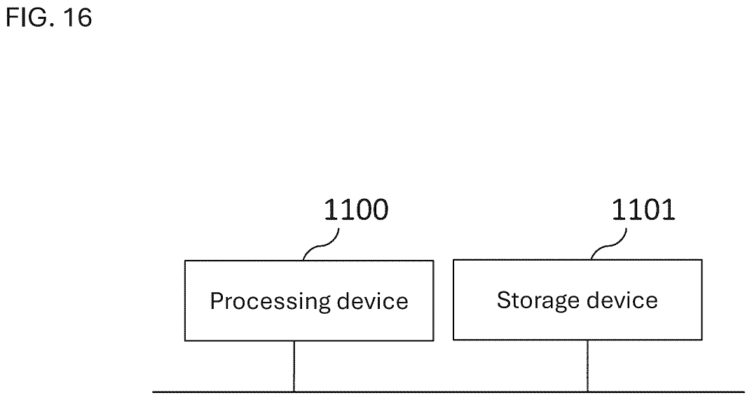

Next, a hardware configuration of the inference device 200 according to Embodiment 1 will be described. Each of the functions of the inference device 200 is realized by a computer. FIG. 16 is a diagram showing an example of a hardware configuration of the computer which realizes the inference device 200.

The hardware shown in FIG. 16 includes a processing device 1100 such as a central processing unit (CPU) and a storage device 1101 such as a read only memory (ROM) and a hard disk.

The mask data acquisition unit 210, the word sequence acquisition unit 220, the type determination unit 230, the control information acquisition unit 240, and the inference unit 250 shown in FIG. 11 are realized by a program stored in the storage device 1101 being executed by the processing device 1100. The above configuration is not limited to a configuration realized by the single processing device 1100 and the single storage device 1101, but may be realized by a plurality of processing devices 1100 and storage devices 1101.

The method of realizing each function of the inference device 200 is not limited to those performed by a combination of hardware and a program described above, but may be realized by hardware alone such as a large scale integrated circuit (LSI) in which a program is implemented in a processing device. Alternatively, a configuration is also possible in which some of the functions are realized by dedicated hardware and remaining functions are realized by a combination of a processing device and a program.

The inference device 200 according to Embodiment 1 is configured as described above.

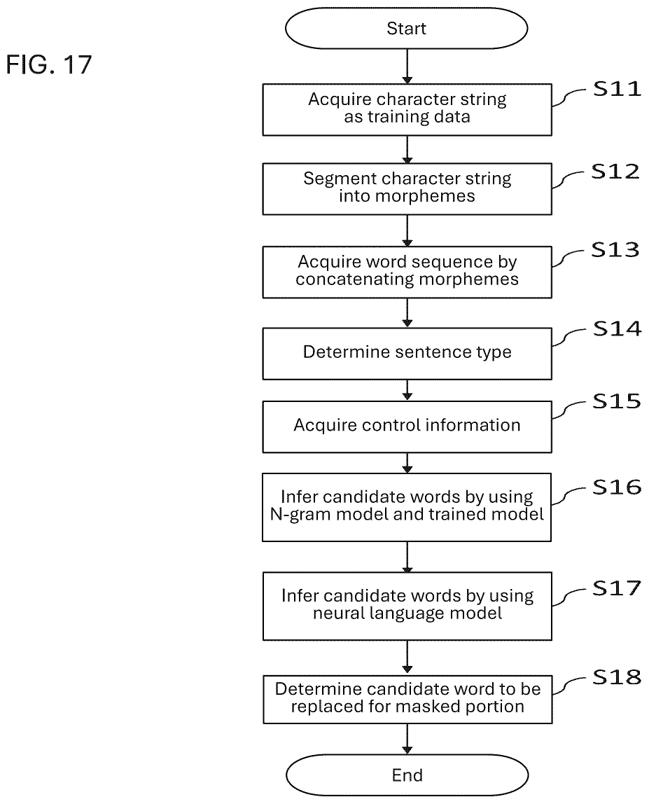

Next, the operation of the inference device 200 according to Embodiment 1 will be described. FIG. 17 is a flowchart showing an operation of the inference device 200 according to Embodiment 1. The operation of the inference device 200 corresponds to an inference method, and the program which causes a computer to perform the operation of the inference device 200 corresponds to an inference program.

The operation of the mask data acquisition unit 210 corresponds to a mask data acquisition process, the operation of the word sequence acquisition unit 220 corresponds to a word sequence acquisition process, the operation of the type determination unit 230 corresponds to a type determination process, the operation of the control information acquisition unit 240 corresponds to a control information acquisition process, and the operation of the inference unit 250 corresponds to an inference process.

First, in step S11, the mask data acquisition unit 210 acquires the character string D11 which includes the masked portion.

Next, in step S12, the morpheme analysis unit 221 segments the character string D11, acquired by the mask data acquisition unit 210 in step S11, into morphemes, which are grammatically minimum units, and acquires the morpheme sequence D12, which includes the plurality of morphemes with the lexical category information attached.

Next, in step S13, the lexicalization unit 222 concatenates the morphemes included in the morpheme sequence D12 acquired by the morpheme analysis unit 221 in step S12 on the basis of the lexical category information and acquires the word sequence D13.

Next, in step S14, the type determination unit 230 determines the sentence type D14 indicated by the word sequence on the basis of the lexical category information included in the word sequence D13 acquired by the word sequence acquisition unit 220 and the notation of the words.

Next, in step S15, the control information acquisition unit 240 acquires the control information D15 (the control word and the control intensity) through user input.

Next, in step S16, the first inference unit 251 acquires the trained model D6 from the trained model storage unit 320 and the N-gram model D5 from the N-gram model storage unit 310, and infers the candidate words for the masked portion by using the pointwise mutual information obtained from the trained model D6 and the N-gram likelihoods obtained from the N-gram model D5. The first inference unit 251 outputs a plurality of the candidate words whose first likelihoods are greater than or equal to a predetermined threshold to the inference result integration unit 253 as the first candidate word group D16.

Next, in step S17, the second inference unit 252 acquires the neural language model D17 from the neural language model storage unit 330 and infers the candidate words for the masked portion by using the acquired neural language model D17. The second inference unit 252 outputs a plurality of the candidate words whose second likelihoods are greater than or equal to a predetermined threshold to the inference result integration unit 253 as the second candidate word group D18.

Finally, in step S18, the inference result integration unit 253 compares the first candidate word group D16 and the second candidate word group D18 and determines a commonly included candidate word as the final inference result, that is, the likely candidate word. The inference result integration unit 253 outputs the character string D19 obtained by replacing the masked portion with the likely candidate word, which is determined as the final inference result, to an external display or speaker.

By the above operation, the inference device 200 according to Embodiment 1 can determine the likely candidate word, which is ethically appropriate, and generate an ethically appropriate sentence by inferring the likely candidate word for the masked portion from the adjectival expression representing a nature or a state of a thing and a word sequence. Here, the character string obtained by replacing the masked portion with the likely candidate word is the generated sentence.

For example, if “yoi (good)” or “utsukushii (beautiful)” is entered as the control word, a word which is highly associated with “yoi (good)” or “utsukushii (beautiful)” is inferred as the likely candidate word. The word which is highly associated with “yoi (good)” or “utsukushii (beautiful)” can be considered as an ethically appropriate word, so that the inference device 200 can infer an ethically appropriate word as the likely candidate word and generate an ethically appropriate sentence by the user or the designer entering a control word having positive meaning.

The inference device 200 according to Embodiment 1 infers the likely candidate word by using the trained model which receives the control word, the words included in the word sequence, and the candidate words and outputs the pointwise mutual information between the control word, the words included in the word sequence, and the candidate words, so that the likely candidate word which is highly related to the control word as well as to the words included in the word sequence can be inferred, and thus, a natural and ethically appropriate sentence can be generated.

Further, the inference device 200 according to Embodiment 1 can infer the likely candidate word more precisely because it determines the sentence type indicated by the word sequence and infers the likely candidate word by using the trained model which is configured to receive the sentence type in addition to the adjectival expression, the words included in the word sequence, and the candidate words, and output the pointwise mutual information.

Furthermore, the inference device 200 according to Embodiment 1 segments a character string into morphemes, which are grammatically minimum units, acquires a morpheme sequence, which includes a plurality of morphemes with lexical category information attached, concatenates the morphemes included in the morpheme sequence on the basis of the lexical category information, and acquires a word sequence. Therefore, by generating a word which summarizes the meanings of the morphemes, the likely candidate word can be inferred more accurately.

### Modification

A modification of the language processing system 10 according to Embodiment 1 will be described.

The learning device 100 and the inference device 200 according to Embodiment 1 are configured to determine the sentence type in order to infer the likely candidate word with better accuracy. However, if accuracy is not required or if the calculation is required to be light, the determination of the sentence type may not be performed, or the learning may be performed only for the affirmative sentences.

The learning device 100 and the inference device 200 are configured to acquire one sentence as the character string and performs the processes one sentence at a time. However, if the sentence type is not to be determined, a plurality of sentences may be processed as one character string.

In Embodiment 1, the inference device 200 is configured to use not only the Adjectival Expression-Term PMI model but also the N-gram model and the neural language model to infer the likely candidate word with better accuracy. However, if accuracy is not required or if the calculation is required to be light, the inference of the likely candidate word may be performed by using only the Adjectival Expression-Term PMI model or by using either the N-gram model or the neural language model in addition to the Adjectival Expression-Term PMI model. If the N-gram model is not to be used, only the control word should be acquired as the control information, since the control intensity is not needed.

The inference device 200 is configured to acquire one word as the control word, but may be configured to acquire a plurality of words for it. If more than one word is used as the control words, for example, PMI in Equation 9 should be the sum of the PMI values for all of the control words.

The order of steps in the flowcharts may be changed as appropriate. For example, the process to generate the trained model in step S9 may be performed before the process to generate the N-gram model in step S8, or the processes of step S8 and step S9 may be performed simultaneously.

For example, the process performed by the second inference unit 252 in step S17 may be performed before the process performed by the first inference unit 251 in step S16, or the processes of step S16 and step S17 may be performed simultaneously. The same is true for the other steps.

The trained model is described for the case in which wₓ and w_{y} are symmetric, but they may be asymmetric. In the above, with respect to the word order of wₓ and w_{y}, it is described that the backward order of the words is added when the learning is performed in order to obtain a learning result which is robust to the sparseness. However, the backward order may not be added to make the meaning given by the word order more distinctive.

### Embodiment 2

Next, Embodiment 2 will be described. In Embodiment 2, a configuration including a bias removal unit to remove bias between two words in addition to that of Embodiment 1 will be described.

In today's emphasis on diversity, it may be ethically inappropriate to assign superiority or inferiority to two things. A learning device 2100 according to Embodiment 2 removes the bias between things indicated by two words by performing a bias removing processing between the two words with respect to a trained model to prevent generation of an unethical sentence.

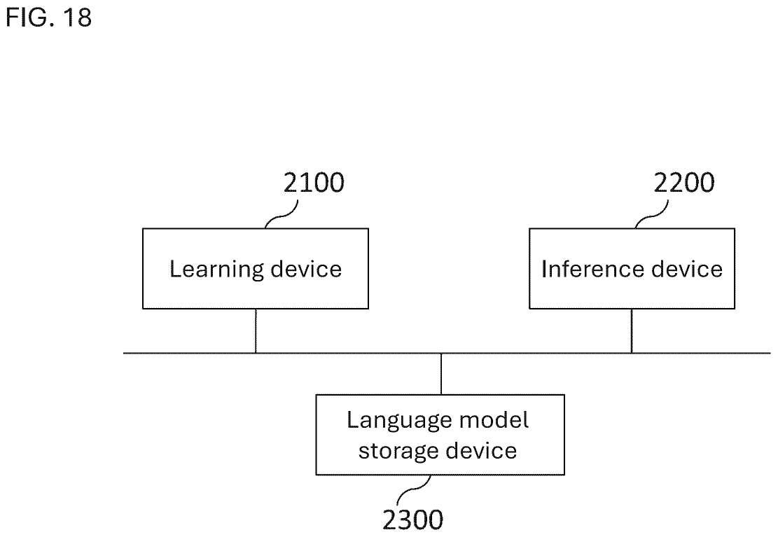

A configuration of a language processing system 2010 according to Embodiment 2 will be described. FIG. 18 is a diagram showing a configuration of the language processing system 2010 according to Embodiment 2. The inference device 2200 of the language processing system 2010 infers the likely candidate word by using a debiased trained model instead of the trained model according to Embodiment 1, and the other configurations are the same as those of the inference device 200 according to Embodiment 1. A language model storage device 2300 stores the debiased trained model instead of the trained model according to Embodiment 1, and the other configurations are the same as those of the language model storage device 300 according to Embodiment 1.

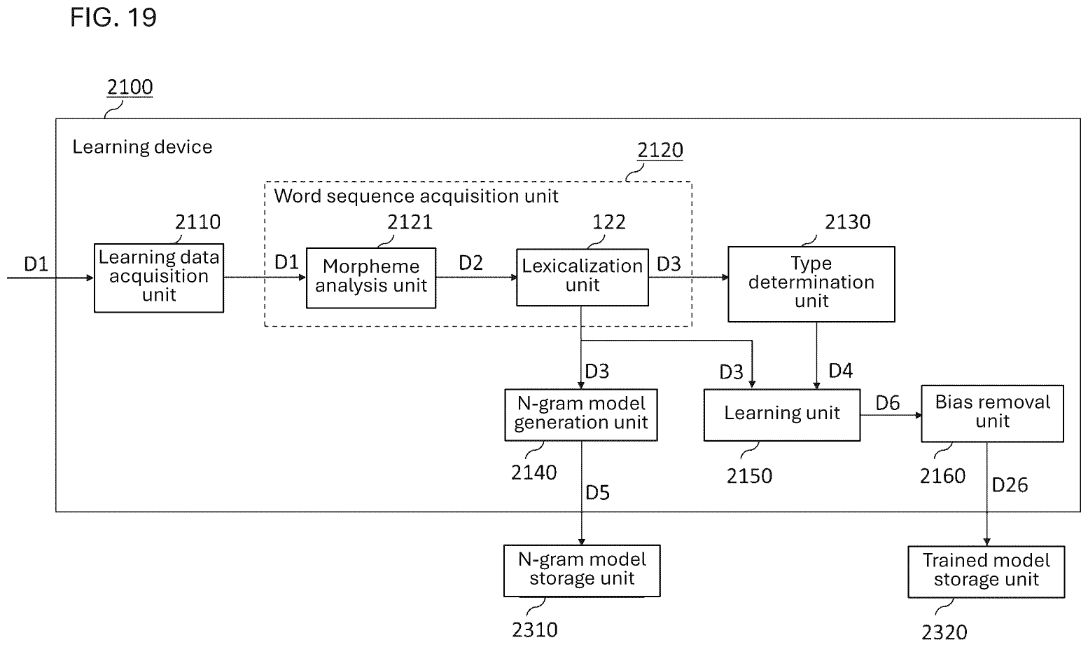

A configuration of the learning device 2100 according to Embodiment 2 will be described. FIG. 19 is a diagram showing a configuration of the learning device 2100 according to Embodiment 2. The learning device 2100 includes a learning data acquisition unit 2110, a word sequence acquisition unit 2120, a type determination unit 2130, an N-gram model generation unit 2140, a learning unit 2150, and a bias removal unit 2160.

The learning data acquisition unit 2110, the word sequence acquisition unit 2120, the type determination unit 2130, the N-gram model generation unit 2140, and the learning unit 2150 perform processes similarly to those in Embodiment 1.

The hardware configuration of the learning device 2100 is the same as the hardware configuration of the learning device 100 according to Embodiment 1 shown in FIG. 8, and the bias removal unit 2160 is realized by a program stored in the storage device 1001 being executed by the processing device 1000.

The bias removal unit 2160 removes the bias between two words by performing the bias removing processing for the trained model D6 generated by the learning unit 2150. More specifically, when it is assumed that the bias is to be removed from between the two words, namely, a first bias word and a second bias word, the bias removal unit 2160 performs the bias removing processing for the trained model D6 to equalize the pointwise mutual information outputted from the trained model D6 when the first bias word is inputted to the trained model D6 and the pointwise mutual information outputted from the trained model D6 when the second bias word, which is different from the first bias word, is inputted to the trained model D6, to generate a trained model D26 with the bias removed.

In Embodiment 2, the bias removal unit 2160 averages the values of the two sets of pointwise mutual information according to Equations 10 through 13 below.

$$PMI ( G , A , {w}_{x} , X ) = \frac{1}{2} ( PMI ( G , A , {w}_{x} , X ) + PMI ( G , A , {w}_{x} , Y ) ) \qquad [ Equation 10 ]$$

$$PMI ( G , A , {w}_{x} , Y ) = \frac{1}{2} ( PMI ( G , A , {w}_{x} , X ) + PMI ( G , A , {w}_{x} , Y ) ) \qquad [ Equation 11 ]$$

$$PMI ( G , A , X , {w}_{y} ) = \frac{1}{2} ( PMI ( G , A , X , {w}_{y} ) + PMI ( G , A , Y , {w}_{y} ) ) \qquad [ Equation 12 ]$$

$$PMI ( G , A , Y , {w}_{y} ) = \frac{1}{2} ( PMI ( G , A , X , {w}_{y} ) + PMI ( G , A , Y , {w}_{y} ) ) \qquad [ Equation 13 ]$$

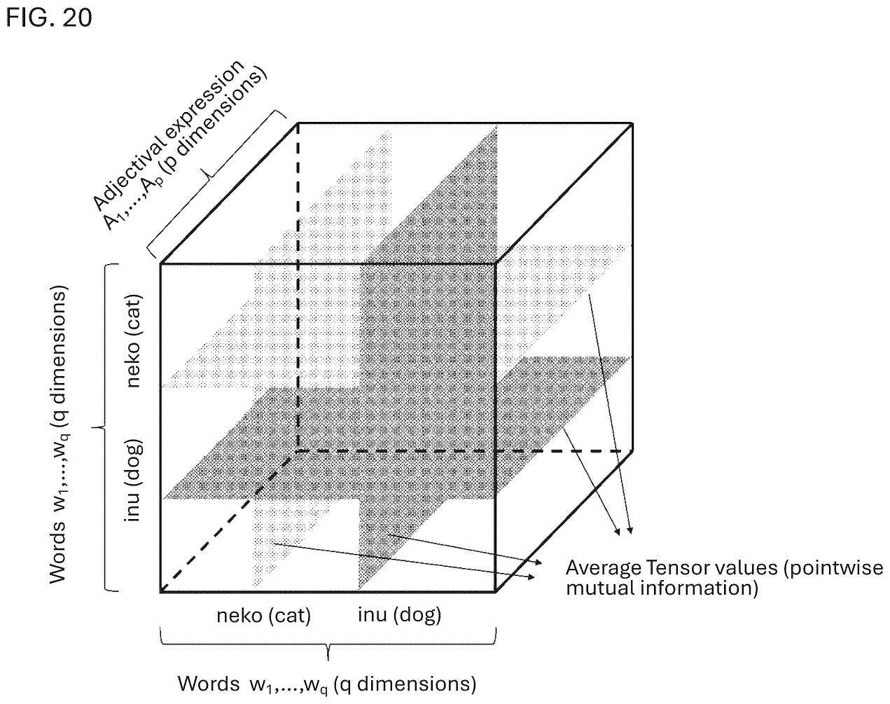

A concrete example of processing of the bias removal unit 2160 will be described using FIG. 20. FIG. 20 is a conceptual diagram to illustrate a concrete example of the processing of the bias removal unit 2160.

For example, assume that the first bias word is “inu (dog)” and the second bias word is “neko (cat)”. Here, by substitution of X=“inu (dog)” and Y=“neko (cat)” in Equations 10 through 13, the pointwise mutual information when “inu (dog)” is included in the triplet of words in the trained model and the pointwise mutual information when “neko (cat)” is included in the triplet of words in the trained model can be equalized.

The learning device 2100 according to Embodiment 2 can generate a trained model with no superiority or inferiority between the two words by generating, as described above, the debiased trained model using the bias removal unit 2160, and thus, the inference device 2200 can avoid a discriminatory representation between the two things by inferring the likely candidate word using the debiased trained model.

The modification in Embodiment 1 is applicable to the language processing system 2010 according to Embodiment 2.

So far, the description has been made using, as an example, the case in which the character string to be processed is Japanese, but it is not limited to this. Both Embodiments 1 and 2 can be applied to languages other than Japanese, for example, English. In this case, it is possible to realize the inference device, the learning device, and the language processing system applicable to languages other than Japanese by using the training data set, the dictionary, etc. for the language to which the embodiments are to be applied.

### INDUSTRIAL APPLICABILITY

The learning device and the inference device according to the present disclosure are suitable for use in a system which automatically generates sentences and engages in conversations with people, such as a chatbot or an automated voice response system.

### DESCRIPTION OF SIGNALS

10, 2010 . . . language processing system,
100, 2100 . . . learning device,
200, 2200 . . . inference device,
300, 2300 . . . language model storage device,
110, 2110 . . . learning data acquisition unit,
120, 2120 . . . word sequence acquisition unit,
121, 2121 . . . morpheme analysis unit,
122, 2122 . . . lexicalization unit,
130, 2130 . . . type determination unit,
140, 2140 . . . N-gram model generation unit,
150, 2150 . . . learning unit,
210 . . . mask data acquisition unit,
220 . . . word sequence acquisition unit,
221 . . . morpheme analysis unit,
222 . . . lexicalization unit,
230 . . . type determination unit,
240 . . . control information acquisition unit,
250 . . . inference unit,
251 . . . first inference unit,
252 . . . second inference unit,
253 . . . inference result integration unit,
310 . . . N-gram model storage unit,
320 . . . trained model storage unit,
330 . . . neural language model storage unit

1. An inference device comprising processing circuitry to perform:
a mask data acquisition process of acquiring a character string which includes a masked portion;
a word sequence acquisition process of segmenting the character string into words and acquiring a word sequence including a plurality of words;
a control information acquisition process of acquiring an adjectival expression representing a nature or a state of a thing as a control word; and
an inference process of inferring a likely candidate word for the masked portion from the control word and the word sequence and outputting the character string in which the masked portion is replaced with the likely candidate word.

2. The inference device according to claim 1, wherein
the word sequence acquisition process includes:
a morpheme analysis process of segmenting the character string into morphemes, which are grammatically minimum units, and acquiring a morpheme sequence including a plurality of morphemes with lexical category information attached; and
a lexicalization process of concatenating morphemes included in the morpheme sequence on the basis of the lexical category information and acquiring the word sequence.

3. The inference device according to claim 1, wherein
the inference process performs inference of the likely candidate word by using a trained model which receives the control word, words included in the word sequence, and candidate words and outputs pointwise mutual information between the control word, the words included in the word sequence, and the candidate words.

4. The inference device according to claim 3, the processing circuitry further performs
a type determination process of determining a sentence type indicated by the word sequence,
wherein the inference process performs inference of the likely candidate word by using the trained model which receives the sentence type in addition to the control word, the words included in the word sequence, and the candidate words and outputs the pointwise mutual information.

5. The inference device according to claim 3, wherein the inference process performs inference of the likely candidate word by using the pointwise mutual information obtained from the trained model and an N-gram likelihood obtained from an N-gram model.

6. The inference device according to claim 5, wherein
the control information acquisition process performs acquisition of weighting factors of the pointwise mutual information and the N-gram likelihood as control intensities, and
the inference process performs inference of the likely candidate word by performing maximum likelihood estimation of a sum of the pointwise mutual information and the N-gram likelihood on the basis of the control intensities.

7. The inference device according to claim 3, wherein
the inference process includes:
a first inference process of inferring candidate words for the masked portion by using the trained model;
a second inference process of inferring candidate words for the masked portion by using a neural language model; and
an inference result integration process of determining a candidate word which is included in common in both a first candidate word group, which is a set of the candidate words inferred in the first inference process and a second candidate word group, which is a set of the candidate words inferred in the second inference process, as the likely candidate word to replace the masked portion.

8. A learning device comprising processing circuitry to perform:
a learning data acquisition process of acquiring a character string as training data included in a training data set;
a word sequence acquisition process of segmenting the character string into words and acquiring a word sequence including a plurality of words; and
a learning process of generating a trained model which receives an adjectival expression representing a nature or a state of a thing and two words and outputting pointwise mutual information between the adjectival expression and the two words on the basis of occurrence probabilities of the words included in the word sequence in the training data set.

9. The learning device according to claim 8, wherein
the learning process performs generation of the trained model on the basis of an occurrence probability, in the training data set, of a first word, which is an adjectival expression and included in the word sequence, an occurrence probability, in the training data set, of a second word included in the word sequence, an occurrence probability, in the training data set, of a third word included in the word sequence, as well as a probability of simultaneous occurrence of the first word, the second word, and the third word in the training data set.

10. The learning device according to claim 8, wherein the processing circuitry further performs
a type determination process of determining a sentence type indicated by the word sequence,
wherein the learning process performs generation of the trained model which receives the sentence type in addition to the adjectival expression and the two words and outputs the pointwise mutual information.

11. The learning device according to claim 8, wherein
the word sequence acquisition process includes:
a morpheme analysis process of segmenting the character string into morphemes, which are grammatically minimum units, and acquiring a morpheme sequence including a plurality of the morphemes with lexical category information attached; and
a lexicalization process of concatenating morphemes included in the morpheme sequence on the basis of the lexical category information and acquiring the word sequence.

12. The learning device according to claim 8, wherein the processing circuitry further performs
a bias removal process of removing a bias for the trained model to equalize the pointwise mutual information outputted from the trained model when a first bias word is inputted to the trained model and the pointwise mutual information outputted from the trained model when a second bias word, which is different from the first bias word, is inputted to the trained model.

13. An inference method comprising:
a mask data acquisition process for acquiring a character string which includes a masked portion;
a word sequence acquisition process for segmenting the character string into words and acquiring a word sequence including a plurality of words;
a control information acquisition process for acquiring an adjectival expression representing a nature or a state of a thing as a control word; and
an inference process for inferring a likely candidate word for the masked portion from the control word and the word sequence and outputting the character string in which the masked portion is replaced with the likely candidate word.

14. A non-transitory storage medium storing an inference program to cause a computer to execute all of the processes according to claim 13.

15. A method for generating a trained model, the method comprising:
a learning data acquisition process for acquiring a character string as training data included in a training data set;
a word sequence acquisition process for segmenting the character string into words and acquiring a word sequence including a plurality of the words; and
a learning process for generating a trained model which receives an adjectival expression representing a nature or a state of a thing and two words and outputs pointwise mutual information between the adjectival expression and the two words on the basis of occurrence probabilities, in the training data set, of the words included in the word sequence.

16. A non-transitory storage medium storing a learning program to cause a computer to execute all of the processes according to claim 15.
